(19) United States
(12) Patent Application Publication
(10) Pub. No.: US 2014/0164044 A1
(43) Pub. Date: Jun. 12, 2014

(54) USE OF ENHANCED USER STATUS TO FACILITATE DOCUMENT WORKFLOW SOLUTIONS

(71) Applicant: XEROX CORPORATION, Norwalk, CT (US)

(72) Inventor: Matthew DeRoller, Webster, NY (US)

(73) Assignee: Xerox Corporation, Norwalk, CT (US)

(21) Appl. No.: 13/706,544

(22) Filed: Dec. 6, 2012

(51) Int. Cl. G06Q 10/06

(52) U.S. Cl. CPC G06Q 10/06312
USPC 705/7.22

(57) ABSTRACT

A document workflow management system monitors progress of a document as it moves between various personnel to whom workflow actions have been assigned. When the system identifies that one of the personnel is causing a delay, or is likely to cause a delay, it will identify an alternate person who may perform the action. It may send the document to the alternate person and then return the document to the original workflow when the alternate person has completed the action.

### BACKGROUND

Workflows are business processes that are designed to achieve a specific purpose. They can be carried out by a single person or piece of equipment, a group, or a whole organization. In the context of document management, one type of workflow is the process by which one or more physical or electronic documents flow among people and/or groups or people for review, editing or other actions. This typically involves documents being distributed with different people responsible for creating, updating, reviewing, and approving the document.

When one or more people involved in a document workflow are not responding quickly, those individuals can create bottlenecks in the workflow. Often it may not be clear why one or more individuals are creating a workflow bottleneck.

This document describes systems and methods that present solutions to the problems discussed above, and which may also provide additional benefits.

### SUMMARY

In an embodiment, a document workflow management system uses one or more processors to access a document workflow file. The document workflow file represents a document management workflow for a document and includes information that may be used for identifying a group of workflow action personnel, an action that is to be taken by each of the personnel, and a time period for each action. The system monitors progress of the document management workflow by aggregating, from two or more sources, user status information for at least a portion of the workflow action personnel. Before the workflow is complete, the system may use the user status information to determine that the document management workflow is subject to a delay based on the user status information for at least one of the workflow action personnel. If so, it may identify the person whose status is a cause of the delay, along with a first action that the person is to perform in the workflow. The system also may analyze the user status information for the identified person to identify a reason for the delay. It may generate an alert comprising an identification of the document, the identified person, and the reason, and it may cause the alert to be transmitted to at least one of the personnel to whom an action has been assigned.

Optionally, if the workflow is subject to an actual or possible delay, the system may identify an alternate person to whom the first action may be assigned, including an identification of the alternate person in the alert; and wait for approval from one of the personnel to whom an action has been assigned before routing the document to the alternate person for the first workflow action. If and when approval is received, the system may cause the document to be transmitted to the alternate person for completion of the first workflow action. Alternatively, if the system determines that a time of the delay exceeds a threshold, it may automatically cause the document to be transmitted to the alternate person for the first workflow action and not wait for approval.

In some embodiments, the system may collect the user status information by accessing a calendar or messaging application that is associated with the identified person. It may analyze data from the calendar or messaging application to determine that the identified person is unavailable until a return time, determine whether the return time is past a threshold time, and if the return time is before the threshold time, it may cause the document to be maintained in a queue for the identified person at least until the threshold time. If the return time is after the threshold time, the system may identify an alternate person to whom the first workflow action may be assigned, and automatically cause the document to be transmitted to the alternate person for the first workflow action.

In some embodiments, the system may collect the user status information by accessing a messaging application that is associated with the identified person, It may analyze data from the messaging application to determine a time when the identified person last used the messaging application to send or read a message, and it may assess whether the determined time is past a threshold time. If the determined time is before the threshold time, the system may cause the document to be maintained in a queue for the identified person at least until the threshold time. If the determined time is after the threshold time, the system may identify an alternate person to whom the first workflow action may be assigned, and automatically cause the document to be transmitted to the alternate person for the first workflow action.

In some embodiments, the system may collect the user status information by accessing a mobile device application that is associated with the identified person. It may analyze data from the mobile device application to determine a time when the identified person last used the mobile device application, and it may assess whether the determined time is past a threshold time. If the determined time is before the threshold time, it may cause the document to be maintained in a queue for the identified person at least until the threshold time. I the determined time is after the threshold time, it may identify an alternate person to whom the first workflow action may be assigned, and automatically cause the document to be transmitted to the alternate person for the first workflow action.

In some embodiments, when identifying an alternate person to whom the first workflow action may be assigned, the system may identify a role that is associated with the alternate person. A role may be a job description, a personal identifier, a security level, or some other categorical identifier. The system may determine whether the document includes any information having an access restriction that applies to the role such that the access restriction restricts access to the information by the alternate person. If the access restriction applies to the role, the system may modify the document to yield a modified document that does not reveal the information, and it may cause the modified document to be transmitted to the alternate person for the first workflow action. Then, after the alternate person performs the first action, the system may use the workflow to select one of the workflow action personnel who is to perform a next workflow action, and it may cause the document, in a form that reveals the information, to be transmitted to the selected person to perform the next workflow action.

In some embodiments, after causing the document to be transmitted to the alternate person for the first workflow action, the system may receive an indication that the alternate person has performed the first workflow action on the document. It may analyze the document to determine whether the first workflow action has been properly completed, and it may cause the document to be sent to a next person to perform a next workflow action only if the first workflow action has been properly completed. Otherwise, it may return the document to the alternate person for re-performance of the first workflow action.

### BRIEF DESCRIPTION OF THE DRAWINGS

FIG. 1 illustrates various elements that may be included in a system that implements a document workflow.

FIG. 2 is a flowchart that illustrates various rules and actions that a document workflow management system may implement.

FIG. 3 illustrates various sources of status information for a workflow action.

FIG. 4 illustrates several optional steps that the system may implement when transmitting, or determining whether to transmit, a document to an alternate person to perform a workflow action.

FIG. 5 illustrates an example of a document workflow dashboard.

FIG. 6 is a block diagram showing various equipment that may be used to implement various embodiments of the processes described in this document.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used in this document have the same meanings as commonly understood by one of ordinary skill in the art. As used in this document, the term “comprising” means “including, but not limited to.”

As used in this document, the term “electronic device” refers to a device that includes a processor and tangible, computer-readable memory. The memory may contain programming instructions that, when executed by the processor, cause the device to perform one or more operations according to the programming instructions. Examples of electronic devices include personal computers, gaming systems, televisions, and portable electronic devices such as smartphones, personal digital assistants, cameras, tablet computers, laptop computers, media players and the like. The term “electronic communication” refers to the ability to transmit data via one or more signals between two or more electronic devices, whether through a wired or wireless network, and whether directly or indirectly via one or more intermediary devices.

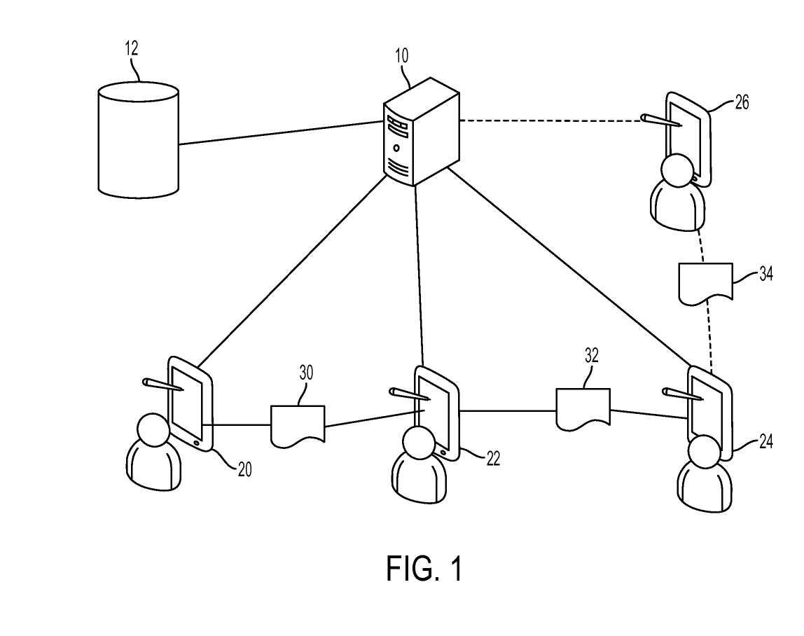

FIG. 1 illustrates various elements that may be included in a system that implements a document workflow. The system includes a processing device 10 such as a network server that coordinates the workflow and monitors the progress of the workflow as the document passes through the system. The processing device 10 is in electronic communication with one or data storage facilities 12 such a database that contains document files and workflow files. Document files will be files containing data for an electronic document, such as a word processing document, a spreadsheet, a presentation, a chart, a media file such as one or more photos or videos, a graphic element or set of graphic elements, or other document. A workflow file will be a file that contains electronic data with one or more instructions or parameters for routing the document file to various document management personnel for creation, modification, review and/or approval of the document. Each workflow file will be associated with one or more document files. A workflow file may be a data structure that is separate from the document file, or it may be integral with the document file, such as in metadata.

The system will include various electronic devices that are used by workflow action personnel. The workflow file may contain identification data for the personnel, such as a username, employee identification code and/or access code. Or, the workflow file may identify each workflow action person based on a network address or an identification code of an electronic device that the person uses. For example, the workflow file may include rules and/or parameters that are established by or set for a first workflow action person 20 who performs a first workflow action on the document. The first workflow action may include, for example, using a first electronic device to create a first draft of the document from a template. The workflow file may then require that the document 30 be sent to a second workflow action person 22 for a second workflow action, such as review and/or edit actions. The second person 22 may create a revised document 32 and transmit it to a third workflow action person 24 for a third workflow action, such as approval.

If the second person 22 is unavailable or not responding to a request to take action on the document, to avoid delays in the workflow the server 10 may cause the document to be sent to an alternate person 26 to perform the second workflow action. The alternate person 26 may create a revised document 34 and transmit it to the third workflow action person 24 for the third workflow action. The server may apply any of various rules for sending the document to the alternate person, such as those that will be described below.

Although FIG. 1 illustrates a system that includes three originally-assigned workflow action personnel and one alternate person, the embodiments disclosed in this document are intended to include systems that involve any number of original and/or alternate personnel.

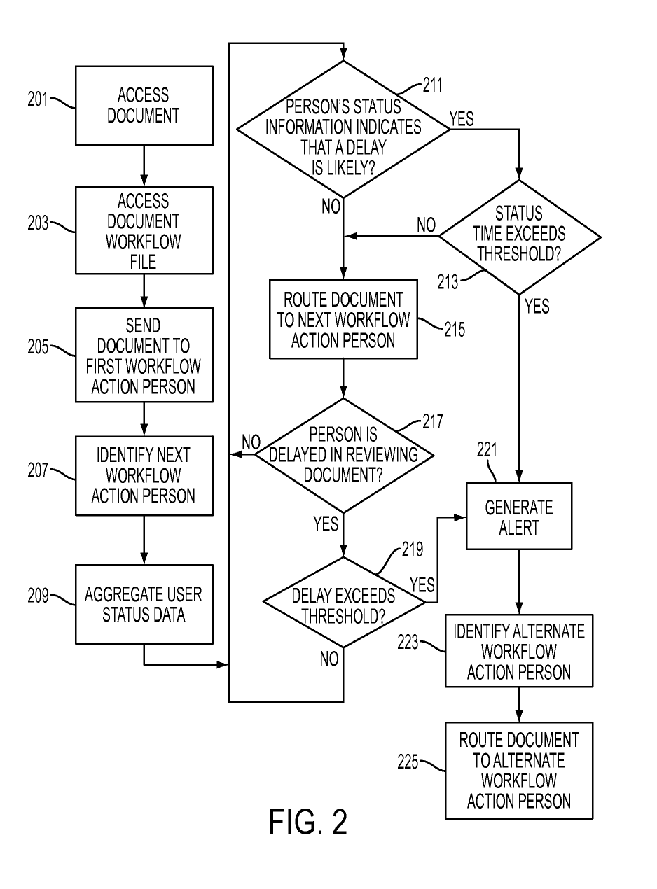

FIG. 2 is a flowchart that illustrates various rules and actions that the workflow management system may implement. The system may begin by accessing an electronic document file 201 and a document workflow file 203 with which the document is associated. The document workflow file represents a document management workflow for the document. It may include rules and/or parameters that identify workflow action personnel to whom the document should be routed, as well as one or more actions to be taken by each of the personnel. The document workflow file also may include a time period, such as a measure of time or a deadline by which one or more of the personnel must complete their assigned action(s). The accessing of the workflow file may be performed by an administrative or hub electronic device (such as server 10 of FIG. 1) and/or by one or more of the workflow action personnel electronic devices. In this document, any such device that performs the described actions may be referred to as a “processor.”

The processor may monitor progress of the document as it moves from person to person in the workflow. For example, the processor may send the document to (or monitor creation document of the document by) a first person 205. After the first person has completed his or her action, the central processor and/or the first person's electronic device may identify, based on the rules and/or parameters in the workflow action file, a next person to whom the document is to transmitted for a second action 207.

The system may then monitor progress of the workflow, and it may determine whether a delay is likely to occur 211, whether a delay is actually occurring 217, or both based on user status information for the personnel to whom workflow actions have been assigned.

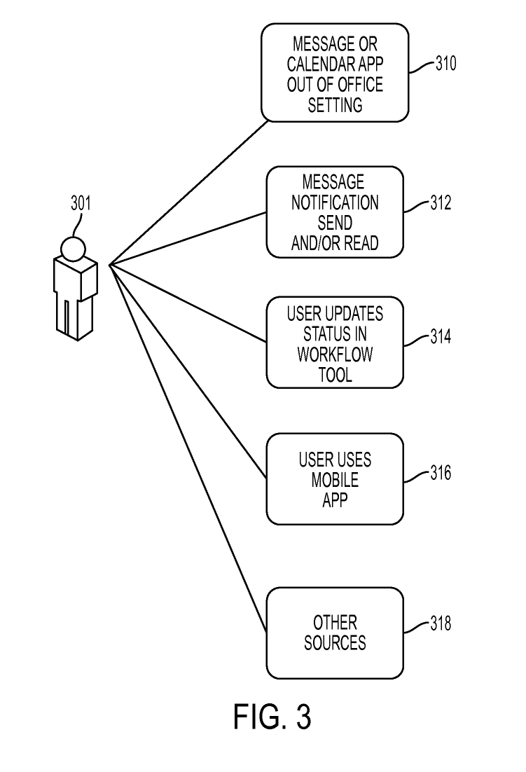

The system may determine whether a delay is likely to occur 211 after it receives and aggregates user status information 209 from a variety of sources for one or more of the workflow action personnel. Referring to FIG. 3, the status information for a workflow action person 301 may be received from a source such as calendar or messaging application 310, where calendar data or an e-mail out of office notification may identify the person as busy or unavailable until a return time. If the return time exceeds a threshold, such as a deadline or a maximum allowable time from the current time, then the system may determine that a delay is likely to occur.

The source may also include a messaging application 312 (such as an electronic mail or text message application), with data such as the last time that the person used the application to send and/or read a particular message, or any message, used to determine a potential delay time. The source may also include a workflow software application 314, with data such as the last time that the person updated his or her status in the application used to determine a potential delay time. The source may also include any mobile electronic device software application 316, with data such as the last time that the person used the application used to determine a potential delay time. The source may include other sources 318, such as a document repository, management system or other business application, with a time of last usage being the data that the system uses to determine the potential for delay. In each of these cases, the potential delay time may be determined by any suitable algorithm, such as whether the time that has elapsed since the user last used the mobile application, updated his or her status in the workflow application, or sent a message via the messaging application exceeds a threshold. If the elapsed time exceeds a threshold, then the system may determine that a delay is likely to occur.

Returning to FIG. 2, if the person's return time, time from since last action, or time received in the status information exceeds a threshold 213, the system may generate an alert 221, identify an alternate person to perform the workflow action 223, and/or send the document to the alternate person to perform the workflow action 225. More details about these steps will be described below. Alternatively, if the system determines that the originally-assigned person's status time does not exceed the threshold 213, it may cause the document to be retained in the originally-assigned person's queue for action 215, either by transmitting the document to that person or by not transmitting the document to an alternate person.

As noted above, once a person has received a document for review, the system also may determine whether a delay is occurring 219 by assessing whether that person has taken his or her assigned action by a determined time 217. The determined time may be a threshold, and any time between transmission of the document to that person and a current time may be considered to be a delay. If the delay exceeds the threshold 219, the system may generate an alert 221, identify an alternate person to whom the workflow action is permitted to be assigned 223, and/or send the document to the alternate person to perform the workflow action 225.

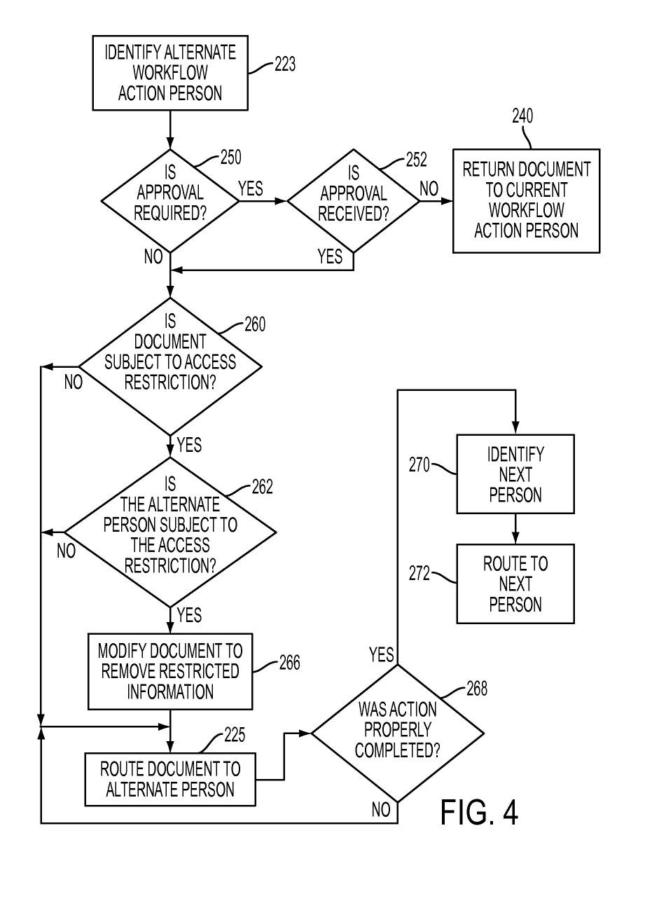

FIG. 4 illustrates several optional steps that the system may implement when transmitting, or determining whether to transmit, a document to an alternate person to perform a workflow action. As noted in FIG. 2, the system may identify an alternate person to perform the workflow action 223. It may do this by accessing a table, database or other data structure to find a person with whom the document has been associated, a person having a role that matches or otherwise corresponds to that of the unavailable person, or a person who has been designated as an alternate person for the unavailable person or the document.

In some situations, the system may automatically route the document to the alternate person 225 as soon as the appropriate criteria (such as a criterion requiring that a delay time exceed a threshold) are satisfied. In other situations, the system may determine whether approval is required from one of the workflow personnel before routing the document to the alternate person 250. If approval is required, the system may send the alert to the person from whom approval is required 252 and wait for the approver to return an approval before sending the document to the alternate person. If approval is returned, then the system may send the document to the alternate person 225. If disapproval is returned, or if approval is not returned within a threshold period of time, then the system may return the document to the original workflow action person 240 and wait for that person to become available.

In some embodiments, the system may determine whether the alternate person is permitted to access the entire document before sending the entire document to the alternate person. For example, the system may determine whether the document includes any information having an access restriction 260, identify a role that is associated with the alternate person 262, and determine whether the access restriction applies to the role such that the access restriction restricts access to the information by the alternate person 264. If the access restriction applies to the alternate person, before sending the document the system may redact, mask or otherwise modify the document so that it does not reveal the information 266. It may then cause modified version of the document to be transmitted to the alternate person for the first workflow action. After the alternate person performs the action, the system may then identify the next workflow action person who is to perform a next workflow action 270. If the next person is not subject to the access restriction, it may then cause the document to be transmitted to the next person in a form that reveals the restricted information 272. For example, before transmitting the document to the alternate person, the system may redact the restricted information from the document and store the redacted information in a memory. The system may then return the redacted information to the document when transmitting it from the alternate person to the next person.

In some embodiments, to confirm that the alternate person has properly performed the action, the system may analyze the document after the alternate person performs the action to determine whether the action was properly completed 268. If may do this by, for example, determining whether all required data entry fields were completed, determining whether data entered satisfied format or other required criteria, or by other analysis methods. If the system determines the action was not properly completed, it may return the document to the alternate person to re-perform the action.

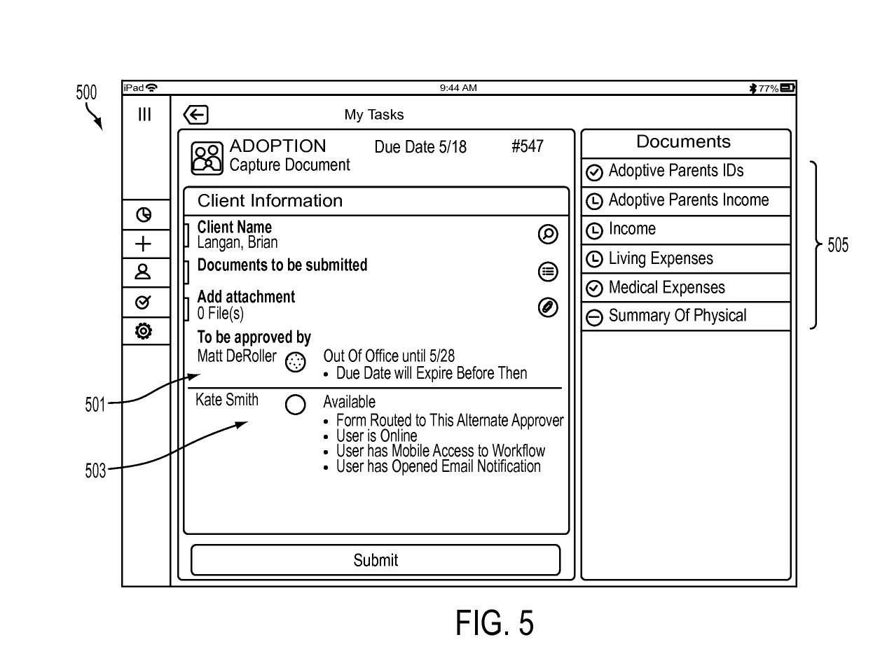

In some embodiments, the system may generate a user interface that includes a document workflow dashboard that may be viewed by one or more of the workflow action personnel on their electronic devices. FIG. 5 illustrates an example of a document workflow dashboard 500. The dashboard may display information such as an identification of one or more documents 505 that are being processed in a workflow, along with status information about one or more of the documents. For example, in the illustration, a check mark may indicate that the document is complete, a clock symbol may indicate that the document is in process, and a straight line may indicate that processing has not yet begun. Other status indicators may be used. If, for any given document, the next person who is to act on the document is unavailable, the dashboard may display an alert 501 along with an identification of an alternate person 503 who is available to perform the action. The alert 501 may include information such as the source or reason explaining why the person is unavailable, and/or when the person will next be available. The alternate person identifier 503 may display information such as the availability of the alternate person, whether or not the document has been routed to and/or acted upon by the alternate person, a role of the alternate person, any access restrictions and/or permissions that may apply to the alternate person, and one or more applications which the alternate person has available for use.

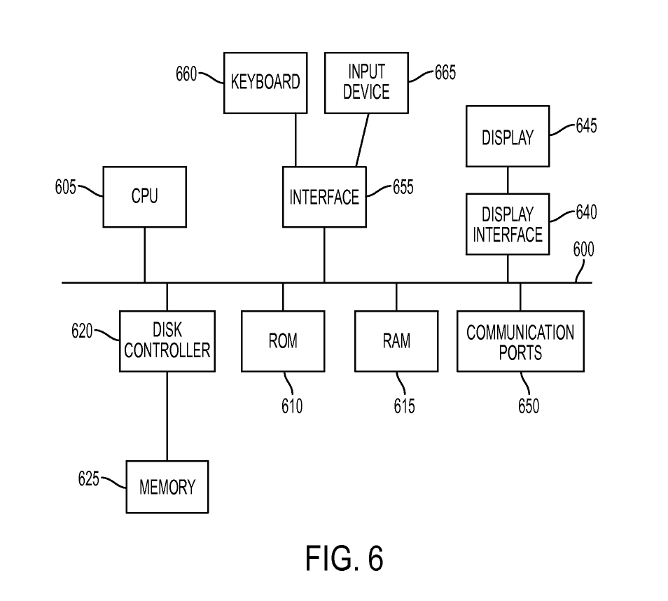

FIG. 6 depicts a block diagram of internal hardware that may be used to contain or implement program instructions according to an embodiment. A bus 600 serves as the main information highway interconnecting the other illustrated components of the hardware. CPU 605 is the central processing unit of the system, performing calculations and logic operations required to execute a program. Read only memory (ROM) 610 and random access memory (RAM) 615 constitute exemplary memory devices.

A controller 620 interfaces with one or more optional memory devices 625 to the system bus 600. These memory devices 625 may include, for example, an external or internal DVD drive, a CD ROM drive, a hard drive, flash memory, a USB drive or the like. As indicated previously, these various drives and controllers are optional devices.

Program instructions may be stored in the ROM 610 and/or the RAM 615. Optionally, program instructions may be stored on a tangible computer readable storage medium such as a compact disk, a digital disk, flash memory, a memory card, a USB drive, an optical disc storage medium and/or other recording medium.

An optional display interface 330 may permit information from the bus 600 to be displayed on the display 635 in audio, visual, graphic or alphanumeric format. Communication with external devices may occur using various communication ports 640. An exemplary communication port 640 may be attached to a communications network, such as the Internet or an intranet.

The hardware may also include an interface 645 which allows for receipt of data from input devices such as a keyboard 650 or other input device 655 such as a mouse, a joystick, a touch screen, a remote control, a pointing device, a video input device and/or an audio input device.

The features and functions disclosed above, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A method comprising, by one or more processors:
accessing a document workflow file, the document workflow file representing a document management workflow for a document, the document workflow file comprising information identifying a plurality of workflow action personnel, an action that is to be taken by each of the personnel, and a time period for each action;
monitoring progress of the document management workflow by:
aggregating, from a plurality of sources, user status information for at least a portion of the workflow action personnel,
before the workflow is complete, determining that the document management workflow is subject to a delay based on the user status information for at least one of the workflow action personnel,
identifying the person whose status is a cause of the delay and a first action that the person is to perform in the workflow, and
analyzing the user status information for the identified person to identify a reason for the delay;
generating an alert comprising an identification of the document, the identified person, and the reason; and
causing the alert to be transmitted to at least one of the personnel to whom an action has been assigned.

2. The method of claim 1, further comprising, by the one or more processors:
identifying an alternate person to whom the first action may be assigned;
including an identification of the alternate person in the alert;
receiving, from one of the personnel to whom an action has been assigned, approval to route the document to the alternate person for the first workflow action; and
in response to receiving the approval, causing the document to be transmitted to the alternate person for completion of the first workflow action.

3. The method of claim 1, further comprising, by the one or more processors:
identifying an alternate person to whom the first workflow action may be assigned;
determining whether a time of the delay exceeds a threshold; and
if the time exceeds the threshold, automatically causing the document to be transmitted to the alternate person for the first workflow action.

4. The method of claim 1, further comprising, by the one or more processors:
accessing a calendar or messaging application that is associated with the identified person;
analyzing data from the calendar or messaging application to determine that the identified person is unavailable until a return time;
determining whether the return time is past a threshold time;
if the return time is before the threshold time, causing the document to be maintained in a queue for the identified person at least until the threshold time; and
if the return time is after the threshold time, identifying an alternate person to whom the first workflow action may be assigned, and automatically causing the document to be transmitted to the alternate person for the first workflow action.

5. The method of claim 1, further comprising, by the one or more processors:
accessing a messaging application that is associated with the identified person;
analyzing data from the messaging application to determine a time when the identified person last used the messaging application to send or read a message;
assessing whether the determined time is past a threshold time;
if the determined time is before the threshold time, causing the document to be maintained in a queue for the identified person at least until the threshold time; and
if the determined time is after the threshold time, identifying an alternate person to whom the first workflow action may be assigned, and automatically causing the document to be transmitted to the alternate person for the first workflow action.

6. The method of claim 1, further comprising, by the one or more processors:
accessing a mobile device application that is associated with the identified person;
analyzing data from the mobile device application to determine a time when the identified person last used the mobile device application;
assessing whether the determined time is past a threshold time;
if the determined time is before the threshold time, causing the document to be maintained in a queue for the identified person at least until the threshold time; and
if the determined time is after the threshold time, identifying an alternate person to whom the first workflow action may be assigned, and automatically causing the document to be transmitted to the alternate person for the first workflow action.

7. The method of claim 1, further comprising, by the one or more processors:
identifying an alternate person to whom the first workflow action may be assigned;
identifying a role that is associated with the alternate person;
determining whether the document includes any information having an access restriction;
determining whether the access restriction applies to the role such that the access restriction restricts access to the information by the alternate person; and
if the access restriction applies to the role, modifying the document to yield a modified document that does not reveal the information, and causing the modified document to be transmitted to the alternate person for the first workflow action.

8. The method of claim 7, further comprising, by the one or more processors:
selecting, based on the workflow, one of the workflow action personnel who is to perform a next workflow action; and
causing the document, in a form that reveals the information, to be transmitted to the selected person to perform the next workflow action.

9. The method of claim 1, further comprising, by the one or more processors:
identifying an alternate person to whom the first action may be assigned;
causing the document to be transmitted to the alternate person for the first workflow action;
receiving an indication that the alternate person has performed the first workflow action on the document;
analyzing the document to determine whether the first workflow action has been properly completed; and
causing the document to be sent to a next person to perform a next workflow action only if the first workflow action has been properly completed, otherwise returning the document to the alternate person for re-performance of the first workflow action.

10. A method of monitoring a document workflow, comprising, by one or more processors:
accessing a document workflow file, the document workflow file representing a document management workflow for a document, the document workflow file comprising information identifying a plurality of workflow action personnel, an action that is to be taken by each of the personnel, and a time period for each action;
monitoring progress of the document management workflow by:
aggregating, from a plurality of sources, user status information for at least a portion of the workflow action personnel, wherein the plurality of sources comprise at least two of the following: a messaging application, a calendar application, a document workflow application, and a mobile device application,
before the workflow is complete, determining that the document management workflow is subject to a delay based on the user status information for at least one of the workflow action personnel,
identifying the person whose status is a cause of the delay and a first action that the person is to perform in the workflow,
analyzing the user status information for the identified person to identify a reason for the delay,
identifying an alternate person to whom the first action may be assigned,
determining whether a time of the delay exceeds a threshold, and
if the time exceeds the threshold, automatically causing the document to be transmitted to the alternate person for the first workflow action.

11. The method of claim 10, further comprising, by the one or more processors:
identifying an alternate person to whom the first workflow action may be assigned;
identifying a role that is associated with the alternate person;
determining whether the document includes any information having an access restriction;
determining whether the access restriction applies to the role such that the access restriction restricts access to the information by the alternate person; and
if the access restriction applies to the role, modifying the document to yield a modified document that does not reveal the information, and causing the modified document to be transmitted to the alternate person for the first workflow action.

12. A document workflow system comprising:
one or more processors;
a data storage facility; and
one or more computer readable media containing programming instructions that, when executed, are configured to instruct one or more of the processors to:
access the data storage facility to retrieve a document workflow file, the document workflow file representing a document management workflow for a document, the document workflow file comprising information identifying a plurality of workflow action personnel, an action that is to be taken by each of the personnel, and a time period for each action;
monitor progress of the document management workflow by:
aggregate, from a plurality of sources, user status information for at least a portion of the workflow action personnel,
before the workflow is complete, determine that the document management workflow is subject to a delay based on the user status information for at least one of the workflow action personnel,
identify the person whose status is a cause of the delay and a first action that the person is to perform in the workflow,
analyze the user status information for the identified person to identify a reason for the delay,
generate an alert comprising an identification of the document, the identified person, and the reason, and
cause the alert to be transmitted to at least one of the personnel to whom an action has been assigned.

13. The system of claim 12, further comprising additional programming instructions that, when executed, are configured to instruct the one or more processors to:
identify an alternate person to whom the first action may be assigned;
include an identification of the alternate person in the alert;
receive, from one of the personnel to whom an action has been assigned, approval to route the document to the alternate person for the first workflow action; and
in response to receiving the approval, cause the document to be transmitted to the alternate person for completion of the first workflow action.

14. The system of claim 12, further comprising additional programming instructions that, when executed, are configured to instruct the one or more processors to:
identify an alternate person to whom the first workflow action may be assigned;
determine whether a time of the delay exceeds a threshold; and
if the time exceeds the threshold, automatically cause the document to be transmitted to the alternate person for the first workflow action.

15. The system of claim 12, further comprising additional programming instructions that, when executed, are configured to instruct the one or more processors to:
access a calendar or messaging application that is associated with the identified person;
analyze data from the calendar or messaging application to determine that the identified person is unavailable until a return time;
determine whether the return time is past a threshold time;
if the return time is before the threshold time, cause the document to be maintained in a queue for the identified person at least until the threshold time; and
if the return time is after the threshold time, identify an alternate person to whom the first workflow action may be assigned, and automatically cause the document to be transmitted to the alternate person for the first workflow action.

16. The system of claim 12, further comprising additional programming instructions that, when executed, are configured to instruct the one or more processors to:
access a messaging application that is associated with the identified person;
analyze data from the messaging application to determine a time when the identified person last used the messaging application to send or read a message;
assess whether the determined time is past a threshold time;
if the determined time is before the threshold time, cause the document to be maintained in a queue for the identified person at least until the threshold time; and
if the determined time is after the threshold time, identify an alternate person to whom the first workflow action may be assigned, and automatically cause the document to be transmitted to the alternate person for the first workflow action.

17. The system of claim 12, further comprising additional programming instructions that, when executed, are configured to instruct the one or more processors to:
access a mobile device application that is associated with the identified person;
analyze data from the mobile device application to determine a time when the identified person last used the mobile device application;
assess whether the determined time is past a threshold time;
if the determined time is before the threshold time, cause the document to be maintained in a queue for the identified person at least until the threshold time; and
if the determined time is after the threshold time, identify an alternate person to whom the first workflow action may be assigned, and automatically cause the document to be transmitted to the alternate person for the first workflow action.

18. The system of claim 12, further comprising additional programming instructions that, when executed, are configured to instruct the one or more processors to:
identify an alternate person to whom the first workflow action may be assigned;
identify a role that is associated with the alternate person;
determine whether the document includes any information having an access restriction;
determine whether the access restriction applies to the role such that the access restriction restricts access to the information by the alternate person; and
if the access restriction applies to the role, modify the document to yield a modified document that does not reveal the information, and cause the modified document to be transmitted to the alternate person for the first workflow action.

19. The system of claim 18, further comprising additional programming instructions that, when executed, are configured to instruct the one or more processors to:
select, based on the workflow, one of the workflow action personnel who is to perform a next workflow action; and
cause the document, in a form that reveals the information, to be transmitted to the selected person to perform the next workflow action.

20. The system of claim 12, further comprising additional programming instructions that, when executed, are configured to instruct the one or more processors to:
identify an alternate person to whom the first action may be assigned;
cause the document to be transmitted to the alternate person for the first workflow action;
receive an indication that the alternate person has performed the first workflow action on the document;
analyze the document to determine whether the first workflow action has been properly completed; and
cause the document to be sent to a next person to perform a next workflow action only if the first workflow action has been properly completed, otherwise return the document to the alternate person for re-performance of the first workflow action.
